(19) United States
(12) Patent Application Publication
(10) Pub. No.: US 2010/0195949 A1
(43) Pub. Date: Aug. 5, 2010

(54) ROLLING BEARING

(76) Inventors: Takashi Yagi, Mie (JP); Kengo Hiramatsu, Mie (JP); Tsukasa Yamakawa, Mie (JP); Makoto Tanaka, Mie (JP); Yosuke Oya, Mie (JP)

Correspondence Address: WENDEROTH, LIND & PONACK, L.L.P., 1030 15th Street, N.W.,, Suite 400 East, Washington, DC, 20005-1503, US

(21) Appl. No.: 12/679,952

(22) PCT Filed: Sep. 24, 2008
(86) PCT No.: PCT/JP2008/067196

§ 371 Date: Mar. 25, 2010

(30) Foreign Application Priority Data
Oct. 25, 2007 (JP) 2007-277614
Feb. 14, 2008 (JP) 2008-033302

(51) Int. Cl. F16C 27/04

(52) U.S. Cl. 384/535

(57) ABSTRACT

A rolling bearing (100) is provided with a dynamic damper (60). A natural frequency of the dynamic damper (60) is caused to coincide with a natural frequency of vibration generated in an entire device. Consequently, it is possible to effectively suppress the vibration generated in the device.

### TECHNICAL FIELD

The present invention relates to a rolling bearing, and more particularly, to a rolling bearing used for a gantry of a computed tomography (CT) scanner device.

### BACKGROUND ART

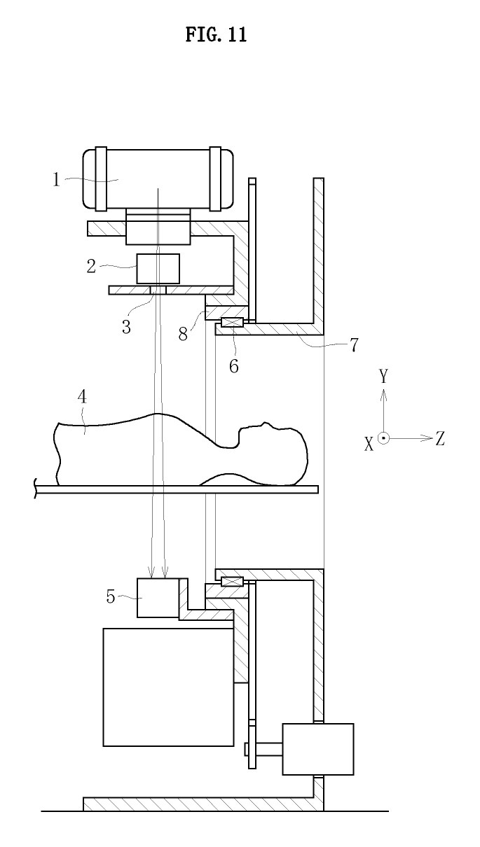

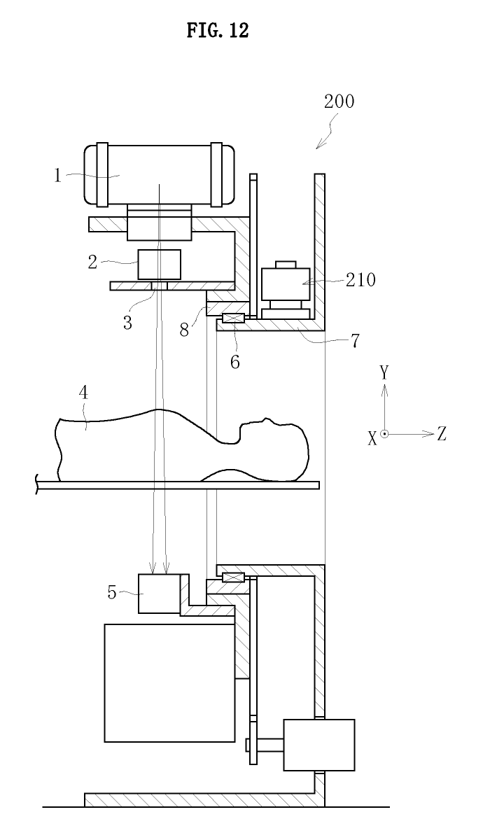

FIG. 11 illustrates an example of a configuration of a CT scanner device. In the CT scanner device, an object 4 is irradiated with an X ray generated by an X ray tube assembly 1 through a wedge filter 2 for uniformizing intensity distribution thereof and a slit 3 for restricting the intensity distribution. The X ray passing through the object 4 is received by a detector 5, converted into an electrical signal, and transferred to a computer (not shown). Components such as the X ray tube assembly 1, the wedge filter 2, the slit 3, and the detector 5 are mounted on a substantially cylindrical rotary member 8 supported rotatably around a stationary frame 7 through a rolling bearing 6, and rotate around the object 4 through rotation of the rotary member 8. In this way, in the CT scanner device, the rotary member 8 which includes the X ray tube assembly 1 and the detector 5 opposed to each other rotates around the object 4. As a result, projection data covering all angles at every point within a cross-section of the object 4 to be examined is obtained. Those pieces of data are transferred to the computer, and a cross-sectional image is obtained by analyzing those pieces of data based on a reconstruction program.

In such CT scanner device, vibration generated in the inside of the bearing coupling rotatably the rotary member to the stationary frame, or vibration caused by a natural frequency, etc. of the rotary member is propagated to the stationary frame, and causes the stationary frame to resonate. Consequently, main body components, performance, and imaging accuracy are sometimes adversely affected. As a countermeasure for this, conventionally, the focus is put mainly on an improvement in rotation accuracy of the bearing.

However, in a device such as the CT scanner device, which includes the rotary member having a large diameter, the stationary frame is prone to have relatively low rigidity, and hence there is exposed a problem such as a reduction in imaging accuracy caused by the vibration of the rotary member and the resonance of the stationary frame. In view of this, in Patent Literature 1, for example, an attempt is made to suppress vibration through interposing a vibration control member between the bearing and the stationary frame.

### Citation List

Patent Literature 1: JP 2005-155745 A

### SUMMARY OF INVENTION

### Technical Problem

However, in the method of suppressing the vibration with the vibration control member as described above, there is a problem that it is impossible to fully suppress the vibration at a resonance point relative to the natural frequency in a relatively low frequency band, which is generated in the entire device such as the CT scanner device.

Therefore, an object of the present invention is to provide a rolling bearing which is incorporated in the CT scanner device or the like, has a large diameter and a small thickness, and is capable of effectively suppressing the vibration caused by resonance of the entire device accompanied with rotation of the rotary member.

### Solution to Problem

In order to solve the above-mentioned problem, according to the present invention, a rolling bearing includes: an outer member having a raceway formed in an inner periphery thereof; an inner member having a raceway formed in an outer periphery thereof; a plurality of rolling elements interposed between the raceway of the outer member and the raceway of the inner member; and a dynamic damper including a damper portion and a weight portion, the damper portion being formed of an elastic body, the weight portion being attached to the outer member or the inner member through the damper portion.

The dynamic damper causes the weight portion to vibrate in opposite phase relative to vibration of the CT scanner device. As a result, vibration in a specific frequency band is intensively suppressed. The natural frequency of the dynamic damper is determined based mainly on the weight of the weight portion and a modulus of elasticity of the damper portion. The natural frequency thereof is caused to coincide with the natural frequency of the device, and thus it is possible to suppress the vibration of the device. Such dynamic damper is provided to the rolling bearing, and the natural frequency of the dynamic damper is adjusted so that the vibration generated in the entire device is suppressed. Accordingly, it is possible to largely enhance a suppressing effect on vibration generated in the device. The bearing as described above is preferably used for, for example, a gantry of the CT scanner device.

In the rolling bearing incorporated in the CT scanner device or the like, in order to avoid interference with other members in the device, a space for installing the dynamic damper is extremely limited. In this context, when a space for accommodating the dynamic damper is provided to the outer member or the inner member, it is unnecessary to provide in the device a new installation space for attaching the dynamic damper. Thus, it is possible to save a space in the device.

Further, when the weight portion is formed into a ring shape along the outer member or the inner member, a small installation space is effectively used, and thus the weight portion having sufficient weight can be obtained. As described above, when the ring-shaped weight portion is provided to the rolling bearing having a large diameter, the weight portion itself has a large diameter and a small thickness in shape, and hence rigidity of the weight portion is decreased. When the natural frequency of the weight portion having low rigidity coincides with the natural frequency of the device, the weight portion itself resonates, and there arises a fear that the weight portion may be fractured in a short period of use. Therefore, it is preferred that the natural frequency of the weight portion be set to be different from the natural frequency of the device in which the dynamic damper is placed.

Further, when the weight portion is formed into the ring shape, the rigidity of the weight portion is decreased as described above. Consequently, machining is difficult, and hence dimensional tolerance is inevitably increased. When the ring-shaped weight portion having increased dimensional tolerance is installed in the bearing, a radial gap between the weight portion and a dynamic damper attachment portion of the bearing is nonuniform. When the radial gap is nonuniform as described above, a tensile force is sometimes applied on some portion of the dynamic damper interposed in the radial gap. In general, in view of durability, it is preferred that the damper portion formed of the elastic body be used in a compressed state. Thus, when the tensile force is applied thereon as described above, there is a fear that the damper portion lacks in durability. In view of this, when a compressing member for compressing the damper portion is provided, the damper portion can be used in the compressed state, and hence it is possible to avoid lack of durability.

In the above-mentioned bearing, the natural frequency to be suppressed differs according to each device incorporating the bearing, and hence it is necessary to prepare dynamic dampers different in the natural frequency from each other according to the natural frequency of each device. Further, in a case where the natural frequency of the dynamic damper is slightly varied due to aged deterioration, it is sometimes necessary to replace the deteriorated dynamic damper for the purpose of fine adjustment of the natural frequency. In view of this, if the natural frequency of the dynamic damper is adjustable in a state in which the dynamic damper is attached to the bearing, the natural frequency of the dynamic damper can be adjusted to the natural frequency corresponding to the device incorporating the bearing. Thus, it is unnecessary to prepare different dynamic dampers according to the device. Further, the natural frequency of the dynamic damper can be caused to coincide with the natural frequency of the device with high accuracy, and hence it is possible to obtain excellent vibration suppressing effect. In addition, in a case where the natural frequency of the dynamic damper is slightly varied due to aged deterioration, etc., the natural frequency can be adjusted without replacing the dynamic damper. Therefore, it is possible to use the same dynamic damper continuously, and to reduce cost and labor.

In this case, for example, between the weight portion and the dynamic damper attachment portion of the bearing, an elastic member having a variable modulus of elasticity is interposed. In this way, the natural frequency of the dynamic damper can be adjusted. When the elastic member is formed into, for example, a conical shape, it is possible to vary the modulus of elasticity through changing the compressed state of the elastic member.

Further, it is also possible to adjust the natural frequency of the dynamic damper through changing the weight of the weight portion. In this case, when the weight portion includes a ring portion and a weight adjustment portion detachably attached to the ring portion, the weight of the weight portion can be easily adjusted through replacing, adding, or eliminating the weight adjustment portion.

In the bearing as described above, if the damper portion is fractured, a fixing state between the weight portion and the bearing is canceled. Consequently, the weight portion is detached from the bearing, and there arises a fear that the weight portion damages its peripheral members. In view of this, when there is provided a pin having one end inserted into a recessed portion formed in the weight portion, and the other end inserted into a recessed portion formed in the dynamic damper attachment portion of the bearing, the pin engages with both of the weight portion and the bearing. As a result, it is possible to prevent the weight portion from being detached from the bearing.

During transportation of the bearing as described above, when vibration and impact load act on the bearing, load larger than had been predicted is applied on the damper portion due to vibration of the weight portion, which leads to a fear that the damper portion is deformed. In view of this, when the rolling bearing provided with the dynamic damper is transported in a state in which the vibration of the weight portion is regulated, the rolling bearing can be transported without application of load on the damper portion, and hence it is possible to prevent deformation of the damper portion. For example, in a case where the bearing is transported while placing its end surface down as a bottom surface, a vibration preventing member is interposed between the weight portion and a member opposed to the weight portion, the vibration preventing member filling a gap therebetween. Consequently, it is possible to regulate the vibration of the weight portion. Alternatively, in a case where the bearing is transported while being incorporated in the device, the weight portion is directly fixed to the device. Consequently, it is possible to regulate the vibration of the weight portion.

Further, in order to solve the above-mentioned problem, according to the present invention, a CT scanner device includes: a stationary frame; a rotary member which is rotatably attached to the stationary frame through a bearing device and rotates around an object; and a dynamic damper for suppressing vibration of the CT scanner device by causing a weight portion attached through a damper portion to vibrate in opposite phase relative to the vibration of the CT scanner device.

The dynamic damper can intensively suppress the vibration in a specific frequency band by causing the weight portion to vibrate in opposite phase relative to the vibration of the device. In this case, it is possible to adjust the natural frequency of the dynamic damper through changing the weight of the weight portion, the size of the damper portion, etc. Therefore, by providing the dynamic damper to the CT scanner device, and by adjusting the natural frequency of the dynamic damper so as to suppress the vibration in a low frequency band, which is generated in the entire CT scanner device, it is possible to largely enhance the suppressing effect on the vibration generated in the CT scanner device.

In order to suppress the vibration of the CT scanner device, when the weight portion of the dynamic damper is made heavy, volume of the weight portion is increased, and a space of more than a certain size is required for installation of the weight portion. However, the rotary member of the CT scanner device is required to ensure a space for attaching an X ray source, an X ray detector, and the like, and hence it is desirable that the dynamic damper be attached to the stationary frame. Alternatively, when the dynamic damper is built in the bearing device, the dynamic damper can be mounted to the CT scanner device without requiring an installation space in the CT scanner device.

Vibration in a plurality of directions occurs in the CT scanner device, and hence it is preferred that the dynamic damper suppress the vibration in the plurality of directions. In particular, of the vibration generated in the CT scanner device, vibration in a rotation axis direction of the rotary member gives great influence on imaging accuracy in X ray imaging. Further, vibration in a direction that is orthogonal to a rotation axis of the rotary member and horizontal to an installation surface is considered to amplify the vibration in the rotation axis direction of the rotary member. Therefore, it is preferred that the dynamic damper suppress the vibration in the rotation axis direction of the rotary member, and the vibration in a horizontal direction, that is, in the direction orthogonal to the rotation axis direction of the rotary member.

In a case where the vibration in the plurality of directions is controlled as described above, when the damper portion has elasticity in the plurality of directions, it is possible to suppress the vibration in the plurality of directions with one dynamic damper. Thus, it is possible to reduce the installation number of the damper portions and to achieve a reduction in attachment space and cost.

The CT scanner device sometimes performs imaging in a state in which the stationary frame is tilted with respect to an object. In this case, a position of center of gravity of the entire device is shifted according to a tilt angle, and hence the natural frequency of the entire device is varied. In this context, when there are provided a plurality of dynamic dampers different in the natural frequency to be suppressed from each other, it is possible to suppress vibration with a plurality of natural frequencies, and to cope with a case where the stationary frame is tilted.

With use of a plurality of dynamic dampers different in the weight of the weight portion and the natural frequency from each other, differences in a vibration suppressing effect of a CT scanner device (about 1.5 t in total weight) were tested. Test results are shown in Table 1. As shown in Test Nos. 1 to 6, among the dynamic dampers of the same weight (30 kg), the dynamic dampers having the natural frequency of a range of 10 to 15 Hz had excellent vibration suppressing effect. Further, in general, a dynamic damper including a weight portion of larger weight has higher vibration suppressing effect. However, as shown in Test Nos. 7 and 12, regarding the dynamic dampers having the natural frequency out of the above-mentioned range, it was found out that the vibration suppressing effect could not be obtained even when the weight of the weight portion was increased. Further, even when the natural frequency was set within the above-mentioned range, when the weight of the weight portion was small as in the case of Test No. 8, the vibration suppressing effect could not be obtained. According to the test results, it is preferred that the dynamic damper be set to have the natural frequency of the range of 10 to 15 Hz, and it is preferred that the total weight of the weight portion be set to 0.5% or more of the weight of the entire CT scanner device, preferably 1.0% or more. Further, an increase of the weight of the weight portion leads to an increase of its volume. Therefore, for installation in the CT scanner device, it is preferred that the total weight of the weight portion be set to 2.5% or less of the weight of the entire CT scanner device, preferably 2.0% or less thereof.

TABLE 1

| Test No. | 1 | | 2 | | 3 | | 4 | | 5 | | 6 | |
|---|---|---|---|---|---|---|---|---|---|---|---|---|
| Natural Frequency | 5 | Hz | 8 | Hz | 10 | Hz | 13 | Hz | 15 | Hz | 18 | Hz |
| Weight of Weight | 30 | kg | 30 | kg | 30 | kg | 30 | kg | 30 | kg | 30 | kg |
| Portion | | | | | | | | | | | | |

| | | | | | | |
|---|---|---|---|---|---|---|
| Vibration | None | None | High | High | High | None |
| Suppressing Effect | | | | | | |

| Test No. | 7 | | 8 | | 9 | | 10 | | 11 | | 12 | |
|---|---|---|---|---|---|---|---|---|---|---|---|---|
| Natural Frequency | 8 | Hz | 10 | Hz | 10 | Hz | 13 | Hz | 15 | Hz | 18 | Hz |
| Weight of Weight | 40 | kg | 5 | kg | 8 | kg | 10 | kg | 10 | kg | 40 | kg |
| Portion | | | | | | | | | | | | |

| | | | | | | |
|---|---|---|---|---|---|---|
| Vibration | None | None | Medium | High | Medium | None |
| Suppressing Effect | | | | | | |

In a case where rust prevention oil or the like is applied to portions of the CT scanner device, there is a fear that the oil adheres to an imaging camera and appears as a shadow in an image, and hence it is preferred not to apply the rust prevention oil or the like as possible. Therefore, as a material of the weight portion of the dynamic damper, a corrosion resistance material is more desirable than an iron-based material. However, aluminum or the like has low specific gravity, and its volume is increased for ensuring the required weight. In this context, it is preferred to use a copper-based material which has characteristics of rust prevention, high specific gravity, and excellent workability and availability.

In order to alleviate a degree of unbalance of the rotary member, a balance weight is sometimes provided to the rotary member in the CT scanner device. In this case, a slight difference is generated in the natural frequency, and hence it is desirable that the natural frequency of each dynamic damper be finely adjustable. For example, it is possible to finely adjust the natural frequency of the dynamic damper through varying the modulus of elasticity of the damper portion by compression or decompression of the damper portion, through changing the weight of the weight portion, or through configuring the damper portion by a plurality of elastic members different in the modulus of elasticity from each other.

### ADVANTAGEOUS EFFECTS OF INVENTION

As described above, according to the present invention, it is possible to provide a rolling bearing capable of effectively preventing vibration due to resonance of the entire device.

### DESCRIPTION OF EMBODIMENTS

In the following, embodiments of the present invention are described with reference to the drawings.

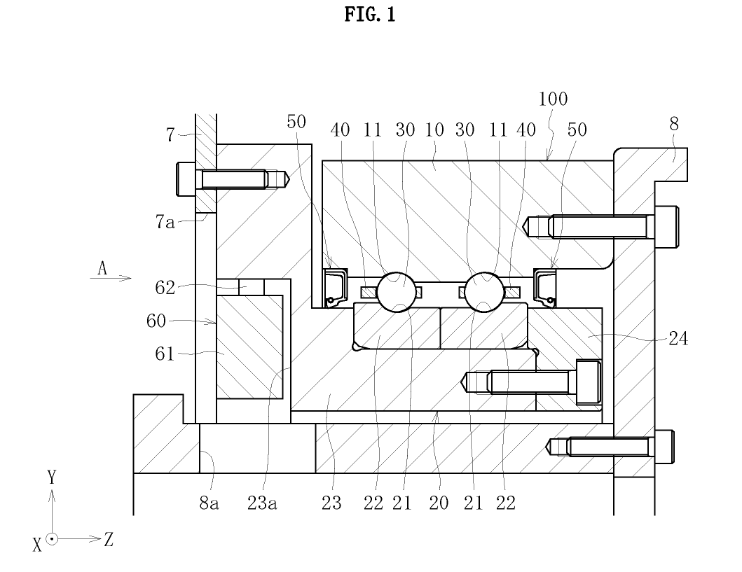

FIG. 1 illustrates a rolling bearing 100 according to an embodiment of the present invention. The rolling bearing 100 is used for, for example, a gantry of a CT scanner device. The bearing 100 in the illustrated example is a double-row ball bearing, and mainly includes an outer member 10 having double-row raceways 11 in an inner periphery thereof, an inner member 20 having double-row raceways 21 in an outer periphery thereof, balls 30 serving as rolling elements interposed between the respective raceways 11 and 21, a cage 40 for retaining the balls 30 in a plurality of directions equiangularly, and seal devices 50 for sealing both ends of an inner space of the bearing. Note that, in the following description, an axial direction of the bearing is indicated by a Z direction (right-left direction in FIG. 1), a direction orthogonal and horizontal to the Z direction is indicated by an X direction (direction orthogonal to a paper plane of FIG. 1), and a direction orthogonal to the X direction and the Z direction is indicated by a Y direction (up-down direction in FIG. 1).

One end surface of the outer member 10 is fixed to the rotary member 8 with a bolt, and thus the outer member 10 serves as a rotating side. The inner member 20 includes two inner races 22 each having a single-row raceway 21 in an outer peripheral surface thereof, a retaining member 23 having an outer periphery onto which the inner races 22 are fitted, and a presser member 24. The two inner races 22 are aligned in the axial direction so that end surfaces of the inner races are brought into contact with each other, and are sandwiched between a shoulder surface of the retaining member 23 and the presser member 24 from both sides in the axial direction. In this state, the presser member 24 is fixed to the retaining member 23 with a bolt. Consequently, the inner member 20 is integrally fixed. The retaining member 23 is fixed to the stationary frame 7 with a bolt, and thus the inner member 20 serves as a stationary side.

The rolling bearing 100 is provided with a dynamic damper 60. In the illustrated example, the dynamic damper 60 is fixed onto an inner peripheral surface of a cutout-like annular recessed portion 23a formed in the retaining member 23 of the inner member 20. The recessed portion 23a forms a space for accommodating the dynamic damper 60. Thus, it is possible to save an installation space for incorporating the rolling bearing 100 in the CT scanner device.

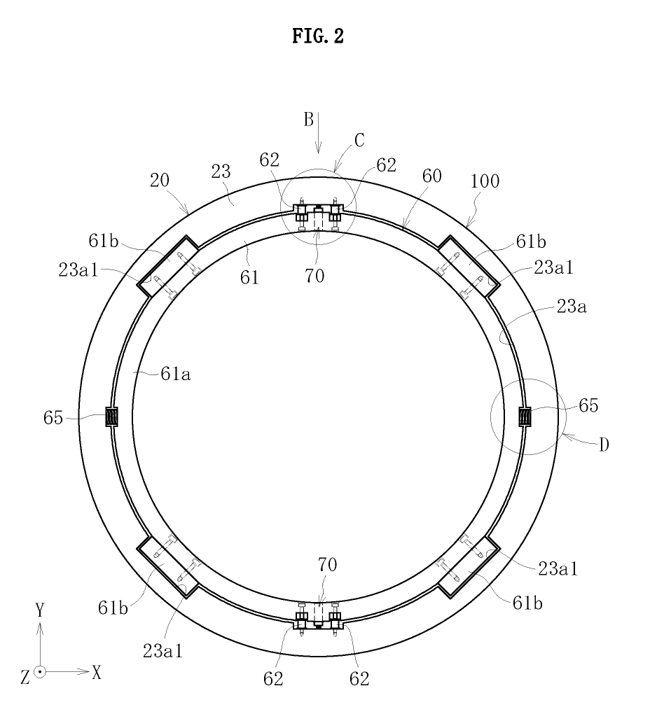

FIGS. 2 to 4 illustrate the dynamic damper 60 in detail. The dynamic damper 60 mainly includes a weight portion 61 and damper portions 62. The weight portion 61 is attached to the retaining member 23 through the damper portions 62. FIG. 2 is a view of the rolling bearing 100 seen from an A direction of FIG. 1. As illustrated in FIG. 2, the weight portion 61 is formed into a ring shape along the inner member 20, and thus it is possible to provide the weight portion 61 while making the most of a space. Specifically, the weight portion 61 is formed into a ring shape along the inner peripheral surface of the annular recessed portion 23a provided in the retaining member 23 (attachment portion of the dynamic damper 60). The weight portion 61 includes a ring portion 61a, and weight adjustment portions 61b provided in the ring portion 61a. The weight adjustment portions 61b are detachably and equiangularly fixed at a plurality of positions (four positions in the illustrated example) on an outer peripheral surface of the ring portion 61a with bolts, etc. In the recessed portion 23a of the retaining member 23, recessed portions 23a1 for accommodating the weight adjustment portions 61b of the weight portion 61 are provided.

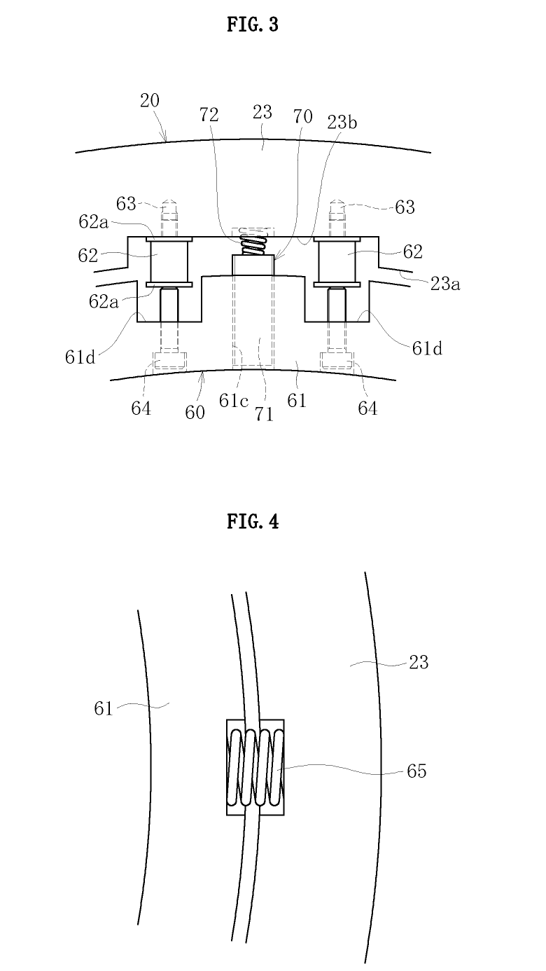

The two damper portions 62 are aligned in a circumferential direction, for example, at each of a uppermost portion and a lowermost portion of the ring-shaped weight portion 61 (see FIG. 2). As illustrated in FIG. 3, in order to ensure an attachment space for the damper portions 62, recessed portions 23b and 61d, to which the damper portions 62 are attached, are formed respectively in the inner peripheral surface of the retaining member 23 and the outer peripheral surface of the weight portion 61. Each of the damper portions 62 is an elastic member formed into a cylindrical shape, and is made of, for example, natural rubber excellent in elasticity and mechanical strength. Circular metal plates 62a are fixed on both end surfaces of each of the damper portions 62 by bonding or the like. The damper portions 62 are fixed on the inner peripheral surface of the recessed portion 23a of the retaining member 23 with bolts 63, and bolts 64 (compressing members) passing through the weight portion 61 compress the damper portions from an radially inner side of the bearing 100.

As described above, each of the damper portions 62 is formed into a cylindrical shape, and has a circular cross-section. Therefore, each of the damper portions 62 has the same modulus of elasticity in the plurality of directions in the circular cross-section, and can exert a vibration suppressing effect in the plurality of directions. For example, in the CT scanner device, it is a big challenge to suppress vibration in the X direction (right-left direction in FIG. 2) and vibration in the Z direction (direction orthogonal to the paper plane of FIG. 2). Accordingly, as illustrated in FIG. 2, by setting the circular cross-section of each of the damper portions 62 to be arranged in a horizontal direction, it is possible to suppress vibration in the X direction and the Z direction. In this way, vibration in the plurality of directions can be suppressed by one damper portion, and hence it is possible to reduce the installation number of the damper portions. In this case, each of the recessed portions 23b, which is formed in the inner peripheral surface of the retaining member 23 and to which the damper portions 62 are attached, is formed to have a horizontal plane, and hence the circular cross-section of each of the damper portions 62 can be arranged to be horizontal. Note that, the shape of each of the damper portions 62 is not limited to the cylindrical shape. For example, even if each of the damper portions 62 is formed into a rectangular column shape having a square cross-section, it is possible to obtain the effect as described above. Further, in this embodiment, as illustrated in FIG. 4, by providing springs 65 on both right and left sides of the weight portion 61, respectively, the weight portion 61 is supported while its vibration is allowed.

As illustrated in FIG. 1, the dynamic damper 60 is attached onto the inner peripheral surface of the inner member 20. With this configuration, the dynamic damper 60 can be completely separated from the inner space of the bearing filled with lubricating oil (space located between the seal devices 50). Consequently, oil resistance is unnecessary for materials of the weight portion 61, the damper portions 62, and the like constituting the dynamic damper 60, and the materials of those members can be selected from a wider variety of materials. In particular, when the damper portions 62 are made of natural rubber inferior in oil resistance as described above, the configuration in the illustrated example is effective. Note that, when the damper portions 62 are made of a material inferior in oil resistance in this way, it is desirable that the dynamic damper be free from contact with another oil such as dustproof oil. Thus, it is preferred that peripheries of the damper portions 62 (for example, the recessed portion 23a of the retaining member 23) be subjected to corrosion resistance coating such as phosphate coating treatment and not subjected to coating of dustproof oil.

The bearing 100 incorporated in the CT scanner device has a large diameter and a small thickness. Thus, the weight portion 61 of the dynamic damper 60 provided in the bearing 100 is also formed into a ring shape having a large diameter and a small thickness. Therefore, rigidity of the weight portion 61 is decreased, and there is a fear that the weight portion 61 itself is damaged due to resonance. In view of this, when a natural frequency of the weight portion 61 is different from a natural frequency of the CT scanner device, it is possible to prevent the weight portion 61 itself from being damaged due to resonance. In a case of the bearing incorporated in the CT scanner device as in this embodiment, the natural frequency of the weight portion 61 may be set to 20 Hz or more.

Further, as described above, the weight portion 61 is formed into the ring shape having the large diameter and the small thickness and has low rigidity, and hence precise machining is difficult and dimensional tolerance is inevitably increased. Therefore, a gap formed between the outer peripheral surface of the weight portion 61 and the inner peripheral surface of the recessed portion 23a of the retaining member 23 varies largely in gap width in the circumferential direction. In this case, as illustrated in FIG. 2, by compressing the damper portions 62 with the bolts 64 passing through the weight portion 61 in a radial direction, the weight portion 61 can be used in a state in which the damper portions 62 are compressed. Specifically, by pushing with the bolts 64 the metal plates 62a fixed on the radially inner side of the damper portions 62, the damper portions 62 are compressed. As a result, regardless of the dimensional tolerance of the weight portion 61, a compressing force can reliably act on the damper portions 62. With this configuration, a tensile force acts on the damper portions 62, and it is possible to prevent a reduction of durability.

In the rolling bearing 100 of the present invention, owing to correspondence between the natural frequency of the dynamic damper 60 and the natural frequency of the CT scanner device, vibration of the device is intensively prevented. Incidentally, when the weight portion 61 of the dynamic damper 60 vibrates, the vibrating weight portion 61 interferes with other members, which may give rise to the failure of the peripheral members such as the rotary member 8. Therefore, it is necessary to set the natural frequency of the dynamic damper 60 in focus on amplitude of the weight portion 61 after considering not only the correspondence with the natural frequency of the device but also deflection and work tolerance of the rotary member 8. The natural frequency of the dynamic damper 60 is determined based mainly on weight of the weight portion 61 and a modulus of elasticity of the damper portions 62. For example, in the bearing incorporated in the CT scanner device, mass of the weight portion may be set to about 5 to 20 kg, and the modulus of elasticity in each direction of the damper portions (dynamic spring constant in a case where the damper portions are made of rubber) may be set to 50 to 250 N/mm.

The dynamic damper 60 includes natural frequency adjusting means 70, and thus the natural frequency of the dynamic damper 60 can be adjusted. In the illustrated example, each of the natural frequency adjusting means 70 includes a bolt 71 and an elastic member 72. The bolt 71 is screwed into a radial thread hole 61c formed in the weight portion 61. The elastic member 72 is formed of, for example, a conical spring. The elastic member 72 is formed into a conical shape as described above, and hence the modulus of elasticity of the elastic member 72 can be varied according to its compressed state. While being compressed, the elastic member 72 is arranged between an end surface of the bolt 71 and the recessed portion formed in the inner peripheral surface of the retaining member 23, and thus the elastic member 72 functions as an auxiliary damper portion of the dynamic damper 60. Note that, the shape of the elastic member 72 is not limited thereto, and any shape may be adopted as long as a cross-sectional area of the elastic member 72 varies in a compressing direction. Further, other than the spring, the elastic member 72 may be formed of another elastic material such as a rubber material.

In the natural frequency adjusting means 70, by fastening or unfastening the bolt 71, the compressed state of the elastic member 72 is changed. In this way, the modulus of elasticity of the elastic member 72 serving as an auxiliary damper can be varied, and hence it is possible to adjust the natural frequency of the dynamic damper 60. Therefore, in a case where the modulus of elasticity of the damper portions 62 is varied due to aged deterioration and the like, and in a case where the natural frequency of the dynamic damper 60 is varied due to replacement of device parts and the like, the natural frequency of the dynamic damper 60 is finely adjusted to the optimum value by fastening and unfastening the bolt 71. Consequently, it is possible to keep the excellent vibration suppressing effect.

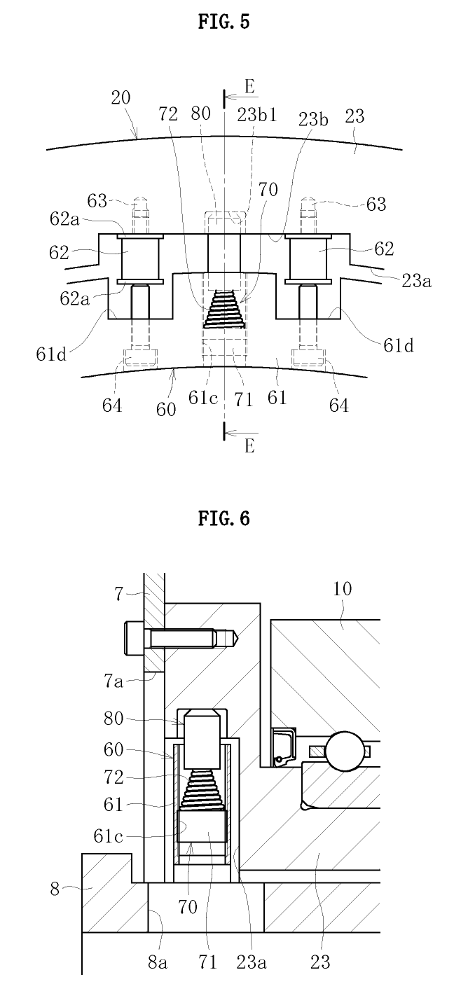

Further, as illustrated in FIG. 6, a radial hole 8a is provided in the rotary member 8 of the CT scanner device. Owing to provision of the radial hole 8a, the bolt 71 of the natural frequency adjusting means 70 is allowed to be operated from the radially inner side of the device. Thus, it is possible to adjust the natural frequency of the dynamic damper 60 in a state in which the bearing 100 is incorporated in the device.

The natural frequency of the dynamic damper 60 can be adjusted by another method. For example, the natural frequency thereof can be adjusted by changing the weight of the weight portion 61. In this embodiment, as illustrated in FIG. 2, the weight portion 61 includes the ring portion 61a, and the weight adjustment portions 61b detachably provided to the ring portion 61a, and hence it is possible to change the weight of the weight portion 61 by replacing the weight adjustment portions 61b with ones different in weight from the weight adjustment portions 61b. Alternatively, it is possible to adjust the natural frequency by replacing the damper portions 62 with ones different in the modulus of elasticity from the damper portions 62. In those cases, it is preferred that at least one axial end surface of the dynamic damper 60 be exposed to the outside so that the weight adjustment portions 61b of the weight portion 61 and the damper portions 62 are allowed to be replaced from the outside. For example, in FIG. 1, a hole 7a is formed in the stationary frame 7. With this configuration, one side in the axial direction (left side in the figure) of the dynamic damper 60 is exposed to the outside.

The present invention is not limited to the above-mentioned embodiment. In the following, another embodiment of the present invention is described. Note that, in the following description, parts having the same configuration and function as those in the above-mentioned embodiment are denoted by the same reference symbols, and description thereof is omitted.

A rolling bearing illustrated in FIGS. 5 and 6 is different from the rolling bearing in the above-mentioned embodiment in that there is provided a pin 80 for preventing the weight portion 61 of the dynamic damper 60 from being separated from the retaining member 23. The pin 80 is made of, for example, a metal material. One end of the pin 80 is inserted into a hole 23b1 formed in the recessed portion 23b of the retaining member 23, and the other end thereof is inserted into the thread hole 61c formed in the weight portion 61. Further, the pin 80 is sandwiched between the elastic member 72 of the natural frequency adjusting means 70 and the bottom of the hole 23b1 of the retaining member 23. The pin 80 is set to have a length long enough to prevent the pin 80 from being detached from the hole 23b1 of the retaining member and the thread hole 61c of the weight portion 61 in a state in which a gap between the weight portion 61 and the retaining member 23 becomes maximum. Owing to provision of the pin 80, even if the damper portions 62 are fractured, the pin 80 engages with both of the hole 23b1 of the retaining member and the thread hole 61c of the weight portion 61. Consequently, it is possible to prevent the weight portion 61 from being detached from the retaining member 23, and to avoid a situation in which the weight portion 61 comes into contact with the rotary member 8 or the like and damages the same. Further, in the illustrated example, the pin 80 is integrally provided to the natural frequency adjusting means 70, and thus it is possible to simplify a manufacturing step and to achieve a cost reduction. Note that, it is not necessarily that the pin 80 is integrally provided to the natural frequency adjusting means 70. The pin 80 may be provided separately at a position of being away from the natural frequency adjusting means 70 in the circumferential direction.

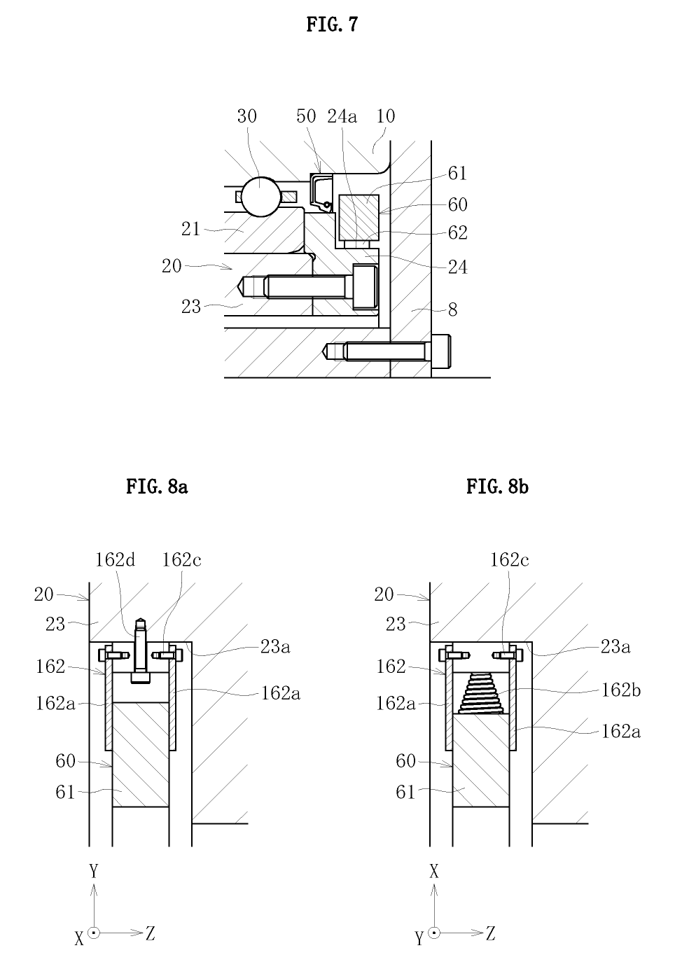

Further, though the dynamic damper 60 is attached onto the inner peripheral surface of the retaining member 23 of the inner member 20 in the embodiment illustrated in FIG. 1, the present invention is not limited thereto. For example, as illustrated in FIG. 7, the dynamic damper 60 may be attached onto the outer peripheral surface of the inner member 20. In the illustrated example, a recessed portion 24a is provided in the outer peripheral surface of the presser member 24 of the inner member 20, and the dynamic damper 60 is attached in a space defined by the recessed portion 24a. In this case, the seal device 50 is arranged between the inner space of the bearing and the dynamic damper 60, and hence the dynamic damper 60 is free from contact with the lubricating oil filled in the inside of the bearing.

Further, though the damper portions 62 are made of rubber in the above-mentioned embodiment, the present invention is not limited thereto. For example, a damper portion 162 illustrated in FIG. 8 includes a pair of leaf springs 162a which are formed into a hollow disk shape and sandwich the ring-shaped weight portion 61 from the both sides in the Z direction (axial direction of the bearing), and a spring 162b arranged on a radially outer side of the weight portion 61. FIG. 8(a) is a sectional view of an uppermost portion of the ring-shaped weight portion 61 (see a part C in FIG. 2), and FIG. 8(b) is a sectional view of a horizontal portion of the weight portion 61 (see a part D in FIG. 2).

The leaf springs 162a are fixed with bolts on both end surfaces of a fixing portion 162c having the substantially axial dimension as that of the weight portion 61. Through fixing the fixing portion 162c with a bolt on the inner peripheral surface of the retaining member 23, the leaf springs 162a are fixed to the inner member 20. The leaf springs 162a are elastically deformed, and the weight portion 61 vibrates in the Z direction. As a result, vibration in the Z direction of the device can be suppressed. In this case, though the leaf springs 162a and the weight portion 61 are held in close contact with each other, they are not fixed to each other. The weight portion 61 is allowed to move in parallel to an X-Y plane (plane orthogonal to the Z direction).

The spring 162b is positioned so that its expanding/contracting direction corresponds to the X direction, and is arranged between the weight portion 61 and the fixing portion 162c while being slightly compressed. As described above, the weight portion 61 is not fixed to the leaf springs 162a and moves in parallel to the X-Y plane while the device vibrates, and hence vibration in the X direction of the weight portion 61 is absorbed by elastic deformation of the spring 162b. Thus, it is possible to suppress vibration in the X direction of the device. Note that, in FIG. 8(b), the spring exhibits a tapered shape decreasing in diameter radially outward, but the present invention is not limited thereto. A cylindrical spring or another elastic member having a modulus of elasticity in the X direction may be used.

In the above-mentioned embodiments, the dynamic damper 60 is attached to the inner member 20 serving as the stationary side. However, in a case where the outer member 10 serves as the stationary side, the dynamic damper 60 may be attached to the outer member 10.

Further, in the above-mentioned embodiments, the case where the bearing 100 is used for the gantry of the CT scanner device is described. However, the present invention is not limited thereto, and a device effectively suppressing the vibration is preferably applicable.

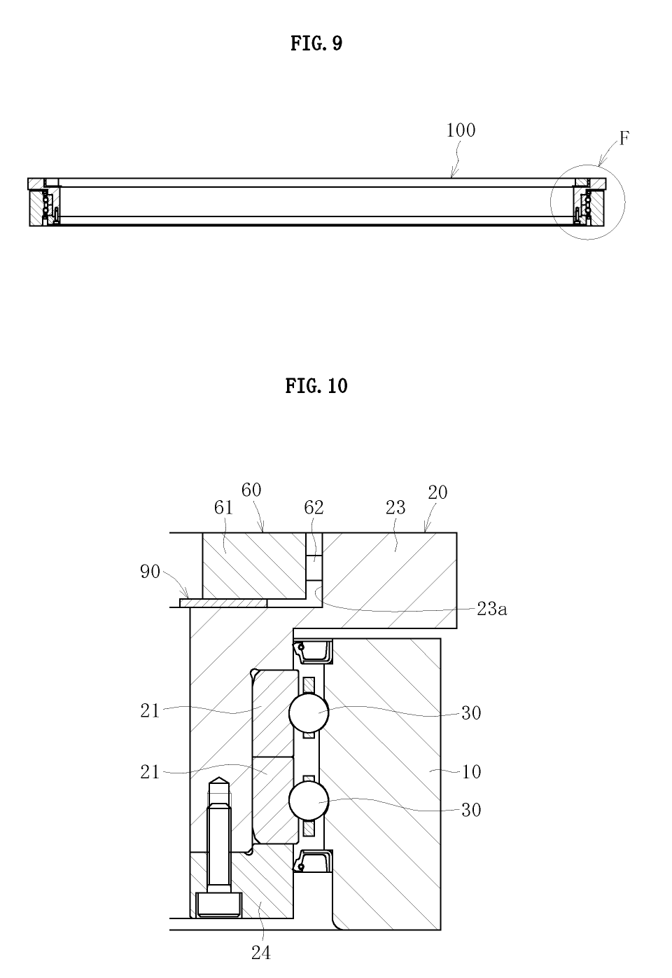

In the following, a transporting method for the above-mentioned bearing 100 is described with reference to FIGS. 9 and 10.

FIG. 9 is a view seen from the B direction of FIG. 2, which illustrates a state in which the bearing 100 is laid down while placing its end surface down as a bottom surface. FIG. 10 is an enlarged sectional view of the part C of FIG. 9. In the illustrated example, there is illustrated a case where the bearing 100 is transported while being laid down with placing down as a bottom surface an end surface opposite to a side on which the dynamic damper 60 is provided, that is, an end surface on the presser member 24 side of the inner member 20. When the bearing 100 is transported in this state, there is a fear that load larger than had been predicted is applied on the dynamic damper 60 due to vibration, impact load, etc. during transportation. In particular, a force in a vertical direction (up-down direction in FIG. 10) is applied on the damper portions 62 due to the gravity of the weight portion 61. Consequently, there arises a fear that the damper portions 62 are deformed. In view of this, as illustrated in FIG. 10, a vibration preventing member 90 is arranged between the weight portion 61 and a surface opposed to the weight portion 61 in the vertical direction (end surface of the recessed portion 23a of the retaining member 23 in the illustrated example), the vibration preventing member 90 filling a gap therebetween. With this configuration, it is possible to suppress the vibration in the vertical direction of the weight portion 61, to alleviate the load applied on the damper portions 62, and to avoid deformation of the damper portions 62.

Further, other than the case where the bearing is transported in a laid posture as described above, in a case where the bearing is transported while being incorporated in the CT scanner device or the like, through fixing the weight portion to the device directly, it is also possible to prevent the deformation of the damper portions caused by the vibration of the weight portion (not shown). In particular, in a case where the bearing is transported in a state in which the rotary member of the CT scanner device is tilted, it is preferred that the weight portion be directly fixed to the device in this way.

In the following, still another embodiment of the present invention is described with reference to the drawings.

FIG. 12 is a sectional view of a CT scanner device 200 according to the present invention. A basic configuration of the CT scanner device 200 is similar to the basic configuration of the conventional CT scanner device illustrated in FIG. 11, but is different in that a dynamic damper 210 is attached to the stationary frame 7.

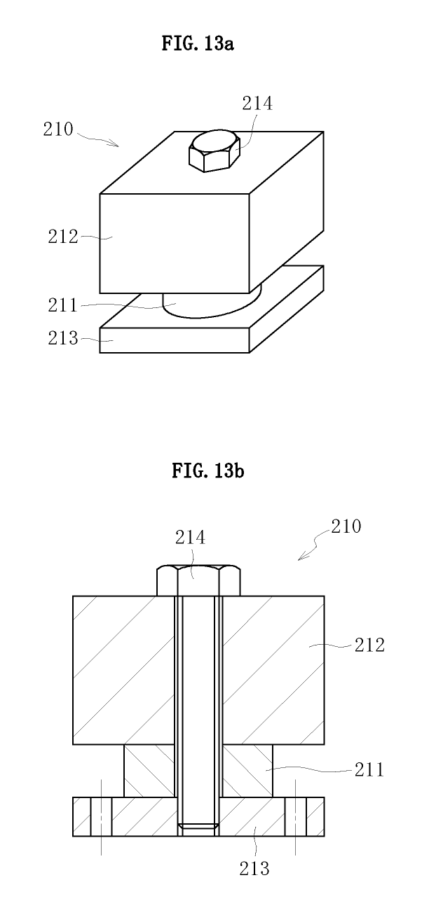

FIG. 13(a) is a perspective view of the dynamic damper 210, and FIG. 13(b) is a sectional view of the dynamic damper 210. The dynamic damper 210 includes a damper portion 211, a weight portion 212, an attachment base 213, and a bolt 214. The damper portion 211, which is made of, for example, a rubber material, is formed into a cylindrical shape, and has a through-hole 211a formed in its center portion. It is preferred that, as the rubber material, natural rubber having a relatively low natural frequency be used. The weight portion 212 has a through-hole 212a formed in its center portion, and is made of a copper-based material which has characteristics of high specific gravity, excellent workability and availability, and rust prevention. The bolt 214 is inserted into the through-hole 211a of the damper portion 211 and the through-hole 212a of the weight portion 212, and a tip end portion of the bolt 214 is screwed into a thread hole 213a of the attachment base 213. With this configuration, the dynamic damper 210 sandwiching the damper portion 211 is constituted between the weight portion 212 and the attachment base 213. The dynamic damper 210 is fixed to the stationary frame 7 with bolts (not shown) passing through fixture holes formed in four corners of the attachment base 213.

The damper portion 211 is designed to have a variable modulus of elasticity. In this embodiment, the damper portion 211 is made of the rubber material, and hence the modulus of elasticity of the damper portion 211 can be varied through fastening the bolt 214 and compressing the damper portion 211 so as to increase the rigidity, or through loosening the bolt 214 so as to decrease the rigidity. Further, though not shown, the damper portion 211 may include a plurality of elastic members (for example, rubber materials) having different moduli of elasticity, and the modulus of elasticity of the entire damper portion 211 may be varied by replacement of the elastic members.

The weight portion 212 is designed to be capable of changing the weight. For example, the bolt 214 is temporarily unfastened, and a copper plate having an inner hole formed therein is placed on the upper surface of the weight portion 212. Then, the bolt 214 is passed through the weight portion 212 and the copper plate, and is fastened again. In this way, it is possible to change the weight of the weight portion 212.

When vibration occurs in the CT scanner device 200, the damper portion 211 of the dynamic damper 210 fixed to the stationary frame 7 is elastically deformed, and the weight portion 212 fixed to the damper portion 211 vibrates through the damper portion 211. The natural frequency of the entire CT scanner device 200 is determined depending on the rpm of the rotary member 8, a configuration of a bearing device 6, etc., and the natural frequency thereof is normally set to 10 to 15 Hz. Therefore, the modulus of elasticity of the damper portion 211 and the weight of the weight portion 212 are appropriately set, and the natural frequency of the dynamic damper 210 is adjusted within a range of from 10 to 15 Hz, to thereby cause the dynamic damper 210 to vibrate in opposite phase relative to the vibration of the device. As a result, it is possible to suppress vibration in a specific frequency band, which is generated in the CT scanner device 200.

Further, in order to alleviate a degree of unbalance of the rotary member 8, a balance weight is often attached to the CT scanner device 200. In this case, each device has the natural frequency slightly different from the natural frequency of another device. Therefore, it is preferred that the natural frequency of the dynamic damper 210 be finely adjustable. In this embodiment, as described above, by varying the modulus of elasticity of the damper portion 211, or by changing the weight of the weight portion 212, it is possible to finely adjust the natural frequency of the dynamic damper 210.

In addition, according to how the CT scanner device 200 is fixed at an installation position, the natural frequency sometimes varies slightly. Therefore, it is desirable that the natural frequency of the dynamic damper 210 be finely adjustable in a state in which only a cover of the CT scanner device 200 is detached (state illustrated in FIG. 12). When the dynamic damper 210 is arranged at, for example, the position as illustrated in FIG. 12, it is possible to finely adjust the natural frequency of the dynamic damper 210 from an outer peripheral side of the device.

The dynamic damper 210 illustrated in FIG. 13 is compressed from the both sides in the up-down direction (Y direction in FIG. 1), and hence the dynamic damper 210 is structured to have the modulus of elasticity mainly in a direction perpendicular to its compressing direction. In other words, the dynamic damper 210 has the modulus of elasticity in the X direction and the Z direction in FIG. 12, and can absorb the vibration in the X direction and the Z direction. Therefore, the vibration in the X direction and the Z direction is absorbed, which has great influence on imaging accuracy of the CT scanner device 200, and hence the dynamic damper 210 can contribute to an improvement of the imaging accuracy. Further, regarding the dynamic damper 210 illustrated in FIG. 13, the vibration in the plurality of directions can be absorbed by one dynamic damper 210. Thus, it is possible to reduce the installation number of the dynamic dampers 210, and to reduce manufacturing cost of the dynamic damper 210 and steps of installing the dynamic damper 210.

Further, as illustrated in FIG. 12, the dynamic damper 210 is attached to the stationary frame 7 having a relatively large space allowing installation, and thus it is possible to increase a size of the weight portion 212 and to enhance the vibration suppressing effect. Further, it is possible to ensure a space for installing the X ray tube assembly 1 and the detector 5 to the rotary member 8.

The present invention is not limited to the above-mentioned embodiments. In the following, another embodiment of the present invention is described. Parts having the same configuration and function as those in the above-mentioned embodiment are denoted by the same reference symbols, and description thereof is omitted.

In the above-mentioned embodiments, the case where the damper portion 211 of the dynamic damper 210 is made of natural rubber is described. However, the present invention is not limited thereto. For example, the damper portion 211 may be formed of another rubber material such as synthetic isoprene rubber, or an elastic metal member such as a compression spring, a Belleville spring, or a leaf spring. In a case where the damper portion 211 is made of a metal material, a stainless-based material is preferably used for the purpose of preventing rust. Further, though the case where the weight portion 212 is made of the copper-based material is described, for example, when there is no problem even if rust prevention oil or the like is applied in the device, the weight portion 212 may be made of another material such as an iron-based material.

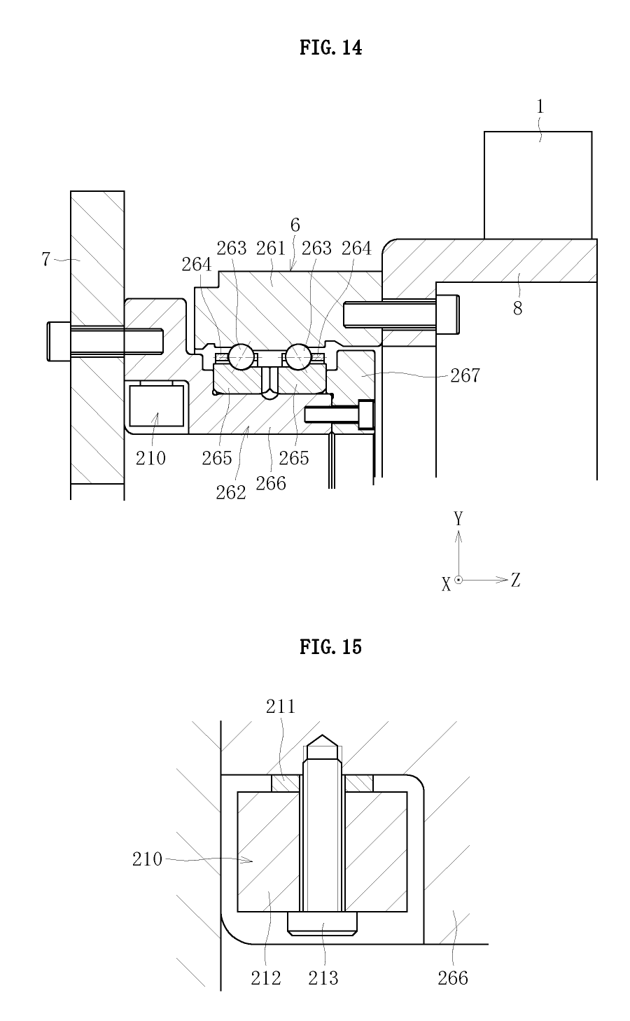

Further, in the above-mentioned embodiments, the separately-formed dynamic damper 210 is fixed to the stationary frame 7. However, the present invention is not limited thereto. For example, as illustrated in FIG. 14, the dynamic damper 210 may be built in the bearing device 6. The bearing device 6 mainly includes an outer member 261 having a raceway in an inner periphery thereof, an inner member 262 having a raceway in an outer periphery thereof, a plurality of rolling elements interposed between the raceway of the outer member 261 and the raceway of the inner member 262, and a cage 264 for retaining the plurality of rolling elements in the circumferential direction. In FIG. 14, the rolling elements are constituted by double-row balls 263, and double-row raceways corresponding to the balls 263 are formed in each of the outer member 261 and the inner member 262. The outer member 261 is molded into a unit, and its one end is fixed to the rotary member 8 with a bolt. The inner member 262 includes double-row inner races 265 each having a raceway in an outer periphery thereof, and includes a retaining member 266 for retaining the double-row inner races 265, the retaining member 266 having one end fixed to the stationary frame 7 with a bolt. The inner races 265 are fitted onto an outer periphery of the retaining member 266, and are positioned and fixed in the axial direction with a fixing member 267.

As illustrated in FIG. 15, the dynamic damper 210 includes the damper portion 211 and the weight portion 212, and is fixed with a bolt to a thread hole formed in the retaining member 266. Specifically, the bolt 213 passes through the through-holes respectively formed in the damper portion 211 and the weight portion 212, and the tip end portion of the bolt 213 is screwed into the thread hole of the retaining member 266. The bolt 213 and the damper portion 211 are fitted to each other with a gap, and the bolt and the weight portion 212 are fitted to each other with a gap. As described above, when the dynamic damper 210 is built in the bearing device 6, it is unnecessary to separately provide a space for installing the dynamic damper 210. Accordingly, it is possible to ensure a space in the CT scanner device. Further, after the dynamic damper 210 is incorporated in the bearing device 6 in advance, the bearing device 6 can be incorporated in the CT scanner device, and hence it is possible to simplify attachment of the dynamic damper 210 to the CT scanner device.

Note that, in FIG. 14, the dynamic damper 210 is built in the retaining member 266 constituting the inner member 262. However, the present invention is not limited thereto. The dynamic damper 210 may be built in the inner races 265, the fixing member 267, or the outer member 261. Further, instead of being molded in a unit, the outer member 261 may be formed to include an outer race and a retaining member for retaining the outer race. Alternatively, the inner races 265 and the retaining member 266 of the inner member 262 may be integrally formed.

Further, the bearing device 6 with the built-in dynamic damper 210 as described above is preferably applicable to the CT scanner device 200 as illustrated in FIG. 12. However, such bearing device is also applicable to another use required to suppress the vibration in the specific frequency band and to save the installation space.

In the above-mentioned embodiments, the inner races of the bearing device 6 are fixed to the stationary frame 7, and the outer race is attached to the rotary member 8. In contrast, the inner races may serve as the rotating side, and the outer race may serve as the stationary side.

Further, in the above-mentioned embodiments, a rotation axis of the rotary member 8 is always horizontal to the installation surface. For example, the rotary member 8 may be tilted by rotating the rotation axis of the rotary member 8 about an axis in the X-axis direction of FIG. 12. As described above, when the rotary member 8 is tilted, a position of center of gravity of the CT scanner device 200 is shifted, and hence the natural frequency of the entire device is varied. In this case, in order to cope with this situation, the plurality of dynamic dampers 210 different in the natural frequency from each other may be attached to the CT scanner device 200, or the damper portion 211 having the modulus of elasticity allowing the variation of the natural frequency at the time of tilting may be used (not shown).

### BRIEF DESCRIPTION OF DRAWINGS

[FIG. 1] A sectional view of a rolling bearing according to an embodiment of the present invention.

[FIG. 2] A front view of the rolling bearing seen from the A direction of FIG. 1.

[FIG. 3] An enlarged front view of a part C of FIG. 2.

[FIG. 4] An enlarged front view of a part D of FIG. 2.

[FIG. 5] A front view of a rolling bearing according to another embodiment of the present invention.

[FIG. 6] A sectional view taken along the E-E line of FIG. 5.

[FIG. 7] A sectional view of the rolling bearing according to another embodiment of the present invention.

[FIG. 8a] A sectional view of the rolling bearing according to another embodiment of the present invention.

[FIG. 8b] A sectional view of the rolling bearing according to another embodiment of the present invention.

[FIG. 9] A side view of the rolling bearing of FIG. 2 seen from the B direction, illustrating a transporting method for the rolling bearing.

[FIG. 10] An enlarged sectional view of a part F of FIG. 9.

[FIG. 11] A sectional view of a conventional CT scanner device.

[FIG. 12] A sectional view of a CT scanner device.

[FIG. 13a] A perspective view of a dynamic damper.

[FIG. 13b] A sectional view of the dynamic damper.

[FIG. 14] A sectional view illustrating a vicinity of a bearing device of a CT scanner device according to another embodiment of the present invention.

[FIG. 15] An enlarged sectional view illustrating a vicinity of the dynamic damper of the bearing device of FIG. 14.

### REFERENCE SIGNS LIST

100 bearing
10 outer member
20 inner member
30 ball
40 cage
50 seal device
60 dynamic damper
61 weight portion
61a ring portion
61b weight adjustment portion
62 damper portion
63 bolt
64 bolt (compressing member)
65 spring
70 natural frequency adjusting means
71 bolt
72 spring
80 pin
90 fixing member

1. A rolling bearing, comprising:
an outer member having a raceway formed in an inner periphery thereof;
an inner member having a raceway formed in an outer periphery thereof;
a plurality of rolling elements interposed between the raceway of the outer member and the raceway of the inner member; and
a dynamic damper comprising a damper portion and a weight portion, the damper portion being formed of an elastic body, the weight portion being attached to the outer member or the inner member through the damper portion.

2. A rolling bearing according to claim 1, which is used for a gantry of a CT scanner device.

3. A rolling bearing according to claim 1, wherein the outer member or the inner member is provided with a space for accommodating the dynamic damper.

4. A rolling bearing according to claim 1, wherein the weight portion is formed into a ring shape along the outer member or the inner member.

5. A rolling bearing according to claim 4, wherein the weight portion is set to have a natural frequency different from a natural frequency of a device incorporating the rolling bearing.

6. A rolling bearing according to claim 4, further comprising a compressing member for compressing the damper portion.

7. A rolling bearing according to claim 1, wherein the dynamic damper has a natural frequency adjustable in a state in which the dynamic damper is attached to the rolling bearing.

8. A rolling bearing according to claim 7, wherein, between the weight portion and a dynamic damper attachment portion of the rolling bearing, an elastic member having a variable modulus of elasticity is interposed.

9. A rolling bearing according to claim 8, wherein the elastic member has a conical shape.

10. A rolling bearing according to claim 8, wherein the weight portion comprises a ring portion, and a weight adjustment portion detachably attached to the ring portion.

11. A rolling bearing according to claim 1, further comprising a pin having one end inserted into a recessed portion formed in the weight portion, and another end inserted into a recessed portion formed in the dynamic damper attachment portion of the rolling bearing.

12. A CT scanner device, comprising the rolling bearing according to claim 1 which is attached to a gantry.

13. A transporting method for a rolling bearing comprising:
an outer member having a raceway formed in an inner periphery thereof;
an inner member having a raceway formed in an outer periphery thereof;
a plurality of rolling elements interposed between the raceway of the outer member and the raceway of the inner member; and
a dynamic damper comprising a damper portion and a weight portion, the damper portion being formed of an elastic body, the weight portion being attached to the outer member or the inner member through the damper portion,
the transporting method comprising transporting the rolling bearing in a state in which vibration of the weight portion is regulated.

14. A transporting method for a rolling bearing according to claim 13, wherein, when the rolling bearing is transported while placing an end surface thereof down as a bottom surface, vibration is regulated through interposing a vibration preventing member between the weight portion and a member opposed to the weight portion, the vibration preventing member filling a gap between the weight portion and the member opposed to the weight portion.

15. A transporting method for a rolling bearing according to claim 13, wherein, when the rolling bearing is transported while being incorporated in a device, vibration is regulated through directly fixing the weight portion to the device.
